(19) United States
(12) Patent Application Publication
(10) Pub. No.: US 2015/0345776 A1
(43) Pub. Date: Dec. 3, 2015

(54) BEVERAGE CONTAINER CONVEYANCE AND ILLUMINATION APPARATUSES AND METHODS

(71) Applicant: Mark Owen Brandon, JR., Audubon, NJ (US)

(72) Inventor: Mark Owen Brandon, JR., Audubon, NJ (US)

(21) Appl. No.: 14/727,057

(22) Filed: Jun. 1, 2015

Related U.S. Application Data
(60) Provisional application No. 62/006,361, filed on Jun. 2, 2014.

(51) Int. Cl. F21V 33/00

(52) U.S. Cl. CPC F21V 33/0004; F21Y 2101/02

(57) ABSTRACT

A beverage container conveyance and illumination apparatus configured to convey a plurality of beverage containers which in some embodiments may comprise: a main housing, a user interface, six beverage container receiving surfaces, and an illumination unit which is configured to illuminate one or more portions of the main housing and/or to illuminate one or more beverage container receiving surfaces. The main housing and/or one or more beverage container receiving surfaces may be made from a transparent, substantially transparent, or translucent material allowing an illumination unit to illuminate one or more portions of the main housing, one or more beverage container receiving surfaces, and/or one or more beverage containers placed on a beverage container receiving surface with random patterns of illumination.

### CROSS REFERENCE TO RELATED APPLICATIONS

This application claims priority to and the benefit of the filing date of U.S. Provisional Application No. 62/006,361, filed on Jun. 2, 2014, entitled “BEVERAGE CONTAINER CONVEYANCE AND ILLUMINATION APPARATUSES”, which is hereby incorporated by reference in its entirety.

### FIELD OF THE INVENTION

This patent specification relates to the field of illuminated beverage containers. More specifically, this patent specification relates to selective illumination and conveyance of one or more beverage containers.

### BACKGROUND

Devices for the illumination of a beverage container are known in the art. One type of illumination device comprises a beverage container with an integrated power source and light element positioned in or on the base of the beverage container. These devices may also allow a user to change the color and intensity of the illumination. However, these devices are only able to illuminate one beverage container and are not able to coordinate the illumination with other illuminated beverage container devices.

Another type of beverage container illumination device comprises an illuminated base configured to convey and illuminate a beverage container that is placed on the device. However, these devices also are only able to illuminate one beverage container and are not able to coordinate the illumination with other illuminated beverage containers or other devices. Similar devices are configured to convey and illuminate a plurality of beverage containers placed on an illumination device, but unfortunately, these devices require all beverage containers on the device to be illuminated in the same manner so that selective illumination of a single beverage container is not possible.

One drawback common to all of these types of illuminated beverage containers is a universal inability to coordinate the selective illumination of a plurality of beverage containers in different lighting configurations and patterns. Since these devices do not allow coordination of illumination between containers, beverage containers used with all of these devices requires either one or all of the containers to be illuminated in the same manner.

Since these illuminated beverage devices requires either one or all of the containers to be illuminated in the same manner, these devices do not lend themselves for use with interactive games between people. Without the ability to selectively coordinate the illumination of one or more beverage containers, users of these devices are solely limited to aesthetic benefits and may not be able to derive any interactive amusement, therefore limiting the utility of the illumination.

Therefore, a need exists for novel apparatuses and systems for beverage container conveyance and illumination. There also exists a need for novel apparatuses and systems for beverage container illumination that are able to coordinate the illumination between beverage containers. There is a further need for novel apparatuses and systems for beverage container illumination that are able to provide selective illumination of a single beverage container out of a set of beverage containers. Finally, there exists a need for novel apparatuses and systems for beverage container illumination that are able to provide interactive amusement utility with illumination.

### BRIEF SUMMARY OF THE INVENTION

A beverage container conveyance and illumination apparatus configured to convey a plurality of beverage containers is provided. In some embodiments, the apparatus may comprise: a main housing, a user interface, a plurality of beverage container receiving surfaces, and an illumination unit which is configured to illuminate one or more portions of the main housing and/or to illuminate one or more beverage container receiving surfaces. The main housing and/or one or more beverage container receiving surfaces may be made from a transparent, substantially transparent, or translucent material allowing an illumination unit to illuminate one or more portions of the main housing, one or more beverage container receiving surfaces, and/or one or more beverage containers placed on a beverage container receiving surface with random patterns of illumination.

In further embodiments, the apparatus may comprise a rotational support rotationally coupled to the main housing which is configured to allow the main housing to rotate relative to a surface that is supporting the apparatus.

In further embodiments, the apparatus may comprise six beverage container receiving surfaces with each beverage container receiving surface configured to receive a beverage container.

According to one aspect consistent with the principles of the invention, a method for illuminating a beverage container conveyance and illumination apparatus is provided. The method may include a user interacting with a user interface. Next, the processing unit may generate a random illumination pattern. The illumination unit may then illuminate a first beverage container receiving surface with a first color of light. The illumination unit may then illuminate a second beverage container receiving surface with a first color of light. The illumination unit may then illuminate a third beverage container receiving surface with a first color of light. The illumination unit may then illuminate a further number of beverage container receiving surfaces with a first color of light until a random number of beverage container receiving surfaces have been illuminated, and then the method may end.

According to another aspect, a method for illuminating a beverage container conveyance and illumination apparatus is provided. The method may include a user interacting with a user interface. Next, the processing unit may generate a random illumination pattern. The illumination unit may then illuminate a first beverage container receiving surface with a first color of light. The illumination unit may then illuminate a second beverage container receiving surface with a second color of light. The illumination unit may then illuminate a third beverage container receiving surface with a third color of light. The illumination unit may then illuminate a further number of beverage container receiving surfaces with colors of light until a random number of beverage container receiving surfaces have been illuminated, and then the method may end.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a perspective view of an example of a beverage container conveyance and illumination apparatus according to various embodiments described herein.

FIG. 2 illustrates a perspective view of an example of a beverage container conveyance and illumination apparatus conveying beverage containers according to various embodiments described herein.

FIG. 3 shows an elevation view of an example of a beverage container conveyance and illumination apparatus conveying beverage containers according to various embodiments described herein.

FIG. 4 depicts a plan view of the bottom of an example of a beverage container conveyance and illumination apparatus according to various embodiments described herein.

FIG. 5 illustrates a block diagram showing some of the elements of an example of a beverage container conveyance and illumination apparatus according to various embodiments described herein.

FIG. 6 shows a perspective view of a user interacting with an example of a beverage container conveyance and illumination apparatus according to various embodiments described herein.

FIG. 7 depicts a perspective view of a user interacting with an alternative example of a beverage container conveyance and illumination apparatus according to various embodiments described herein.

FIG. 8 illustrates a block diagram of an example of a method for illuminating a beverage container conveyance and illumination apparatus according to various alternative embodiments described herein.

FIG. 9 shows a block diagram of an example of a method for illuminating a beverage container conveyance and illumination apparatus according to various alternative embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

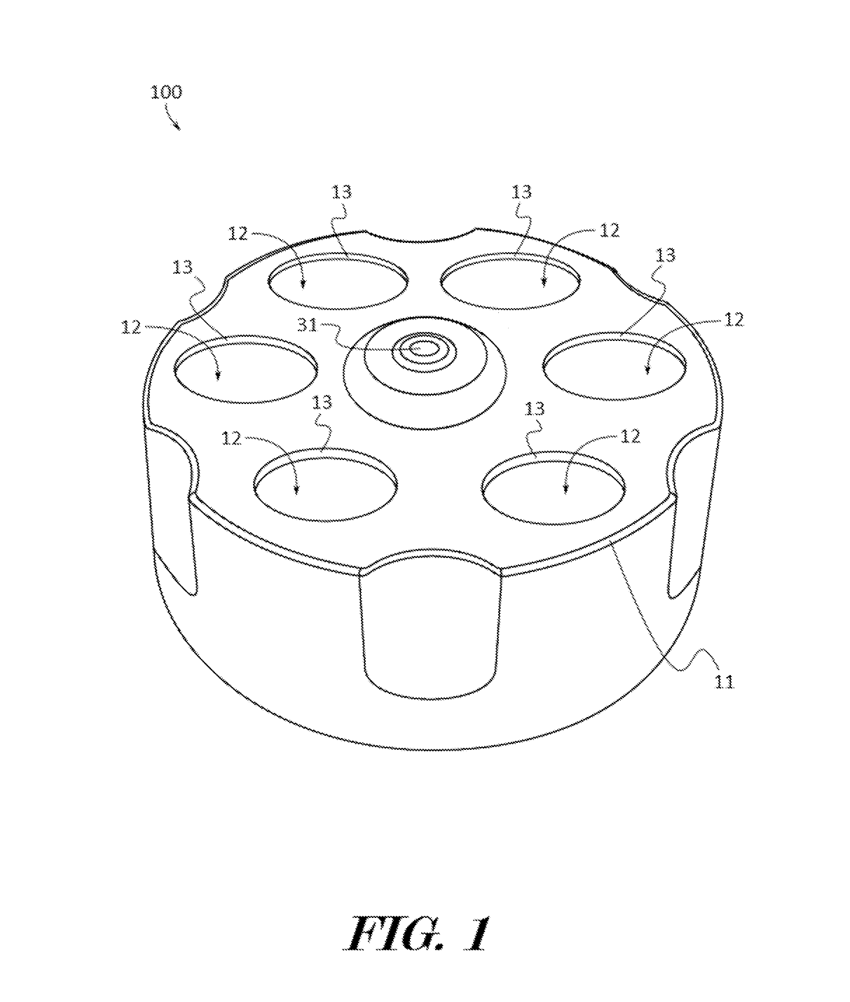

For purposes of description herein, the terms “upper”, “lower”, “left”, “rear”, “right”, “front”, “vertical”, “horizontal”, and derivatives thereof shall relate to the invention as oriented in FIG. 1. However, one will understand that the invention may assume various alternative orientations and step sequences, except where expressly specified to the contrary. Therefore, the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

New beverage container conveyance and illumination apparatuses and methods are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

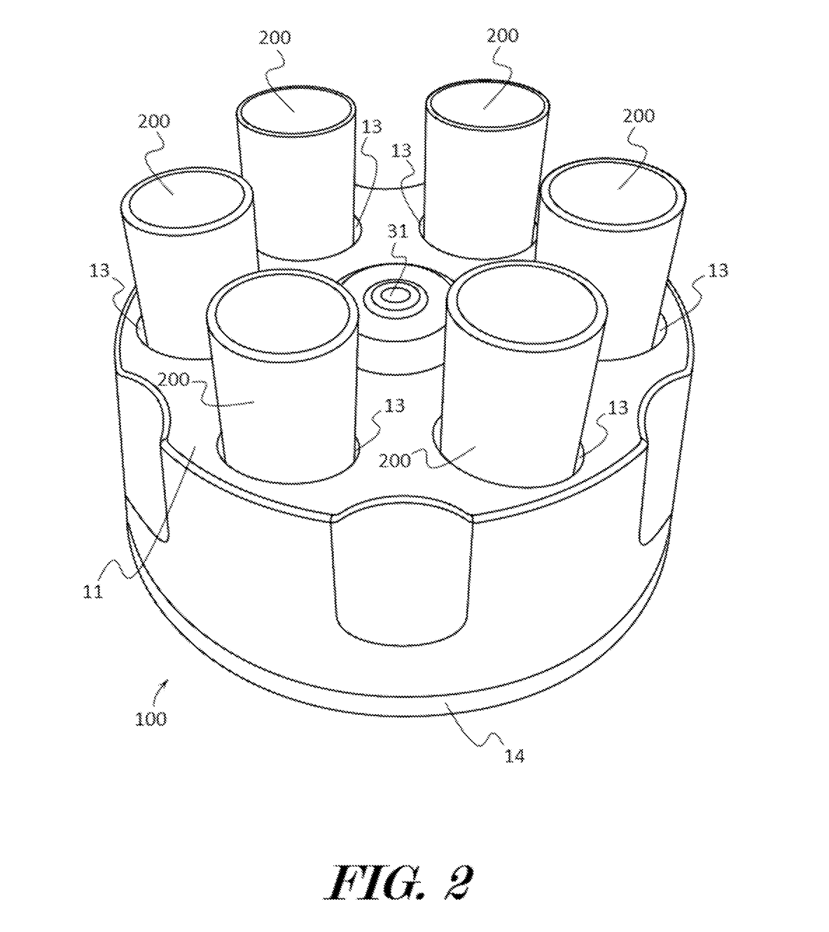

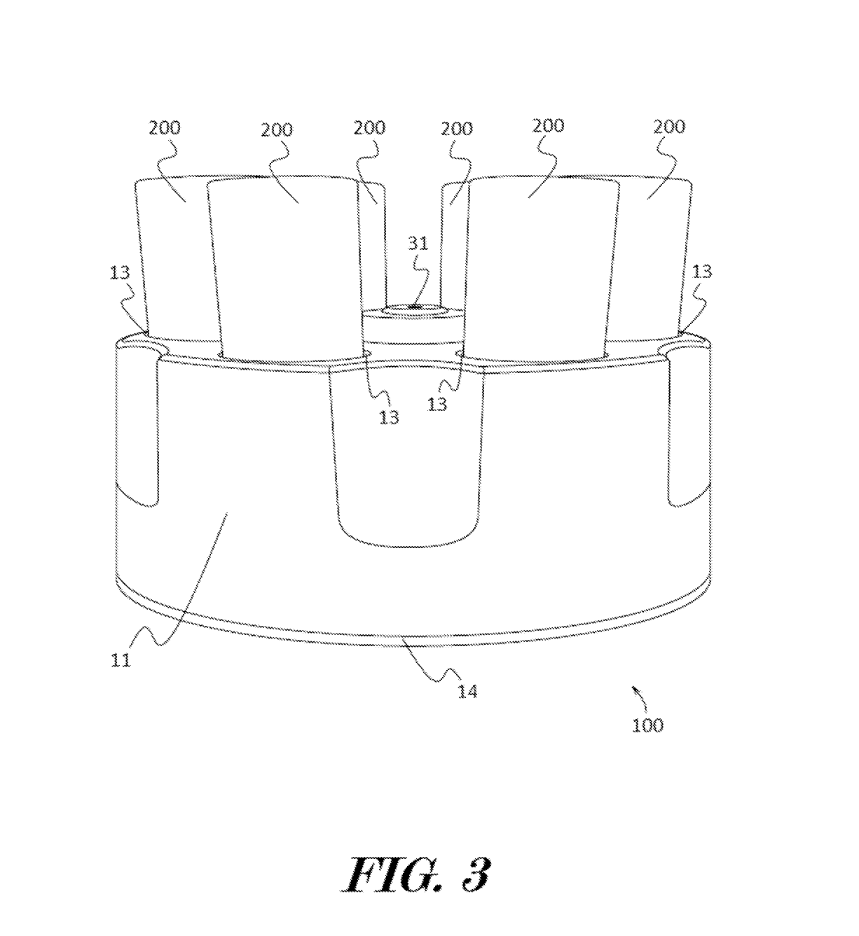

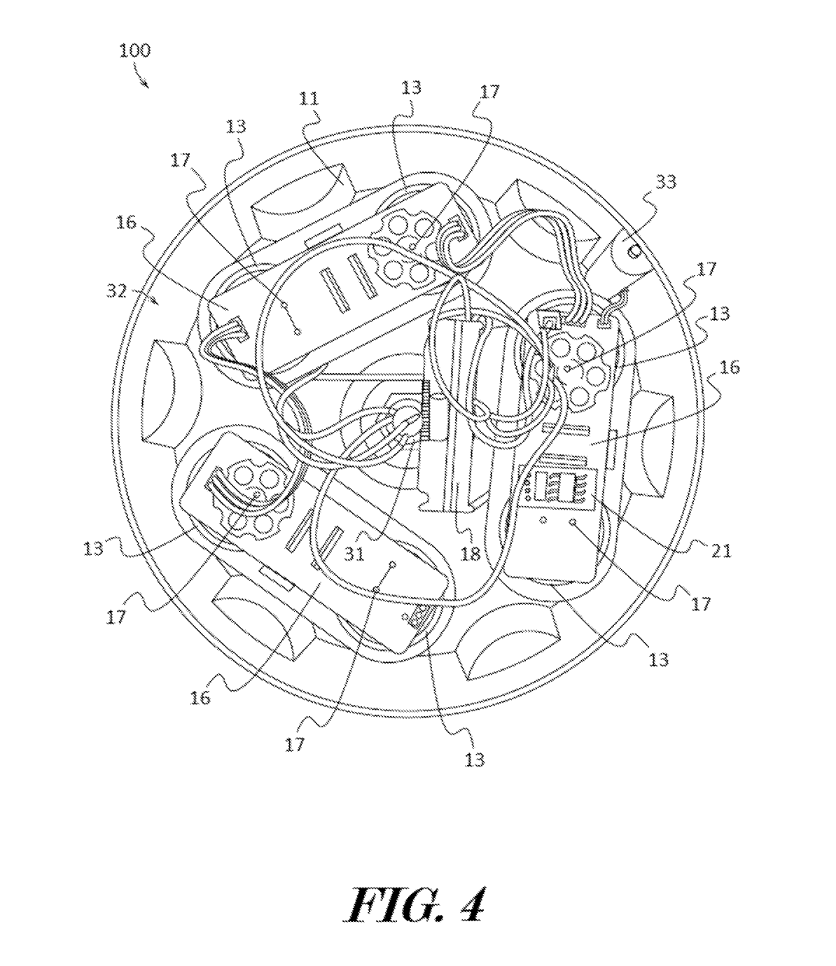

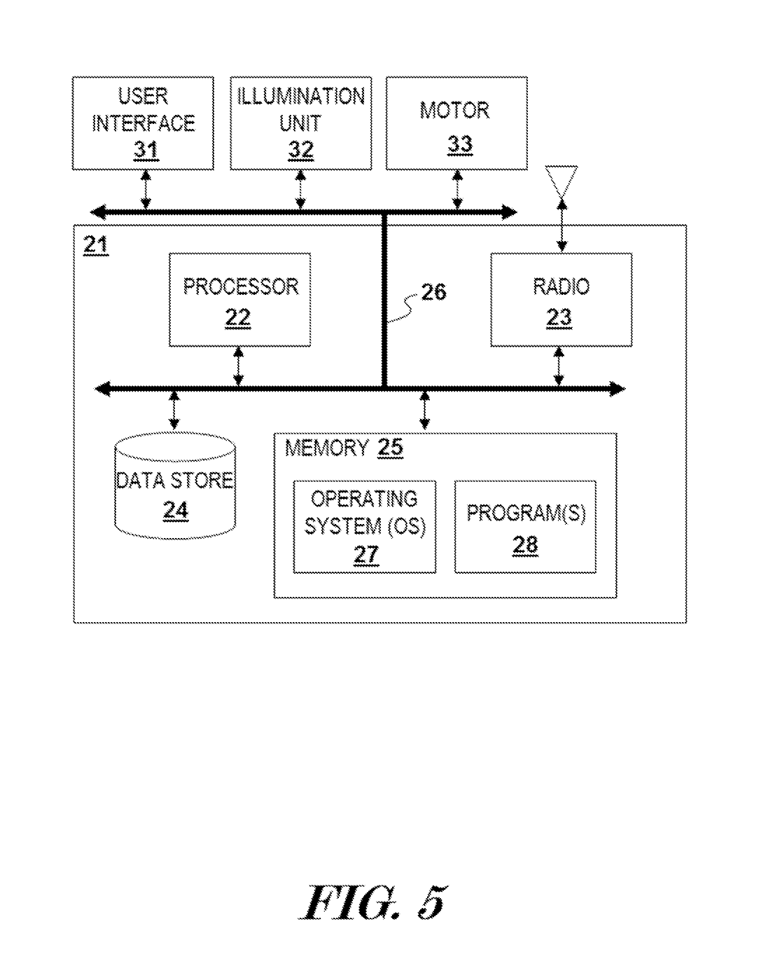

The present invention will now be described by example and through referencing the appended figures representing preferred and alternative embodiments. FIG. 1 illustrates an example of a beverage container conveyance and illumination apparatus (“the apparatus”) 100 according to various embodiments. In this example, the apparatus 100 comprises a main housing 11, a user interface 31, six beverage container receiving surfaces 12, and an illumination unit 32 (FIGS. 4 and 5) which is configured to illuminate one or more portions of the main housing 11 and/or illuminate one or more beverage container receiving surfaces 12. The main housing 11 and/or one or more beverage container receiving surfaces 12 may be made from a transparent, substantially transparent, or translucent material allowing an illumination unit 32 to illuminate one or more portions of the main housing 11, one or more beverage container receiving surfaces 12, and/or one or more beverage containers 200 (FIGS. 2 and 3) placed on a beverage container receiving surface 12.

In some embodiments, a beverage container receiving surface 12 may be configured to receive one beverage container 200 and an apparatus 100 may comprise one, two, three, four, five, six, seven, eight, or more, such as a plurality of beverage container receiving surfaces 12, allowing a main housing 11 to receive and convey one, two, three, four, five, six, seven, eight, or more, such as a plurality of beverage containers 200 as shown in FIGS. 2 and 3. In other embodiments, a beverage container receiving surface 12 may be configured to receive two, three, four, five, six, seven, eight, or more, such as a plurality of beverage containers 200 and an apparatus 100 may comprise one, two, three, four, five, six, seven, eight, or more, such as a plurality of beverage container receiving surfaces 12, allowing a main housing 11 to receive and convey one, two, three, four, five, six, seven, eight, or more, such as a plurality of beverage containers 200.

In this embodiment, the beverage container receiving surfaces 12 are configured with an open cylindrical shape. A beverage container receiving surface sidewall 13 may join a beverage container receiving surface 12 to the main housing 11. A beverage container receiving surface sidewall 13 may be recessed into the main housing 11, so that a portion of a beverage container 200 such as a cup, shot glass, drinking cup, mug, tumbler, or any other beverage container may be received in the main housing 11 when a beverage container 200 is positioned on a beverage container receiving surface 12 as shown in FIGS. 2 and 3. In other embodiments, a beverage container receiving surface 12 may be configured with a recessed open rectangular prism, triangular prism, hexagonal prism, tetrahedron, square pyramid, cone, sphere, or any other 3D geometric shapes including combinations of shapes. In further embodiments, one or more recessed beverage container receiving surfaces 12 may be configured with a lid or other securing fastener configured to secure a beverage container 200 to a beverage container receiving surface 12. In still further embodiments, a beverage container receiving surface 12 may be configured with a generally planar or tray shape that may extend across an upper portion of the main housing 11 allowing a beverage container receiving surface 12 to receive one, two, three, four, five, six, seven, eight, or more beverage containers 200.

Optionally, a beverage container receiving surface 12 may be configured to receive items such as tokens, game pieces, or other identifying characters which may be used with board games, skill games, or any other games and even for team selection processes.

FIGS. 2 and 3 illustrate an example of a beverage container conveyance and illumination apparatus 100 conveying beverage containers 200 according to various embodiments described herein. In this embodiment, the apparatus 100 comprises a main housing 11 joined to a rotational support 14 positioned between the main housing 11 and a surface upon which the apparatus 100 may be placed allowing the apparatus 100 to rotate relative to a surface that is supporting the apparatus 100. The rotational support 14 may generally extend to the lower perimeter of the main housing 11 as shown, or it may be recessed under the main housing 11 and generally not be visible. In some embodiments, the rotational support 14 may comprise one or more support legs or arms which may be configured to contact the surface upon which the apparatus 100 is placed.

The rotational support 14 may be rotationally coupled to the main housing 11 with one or more plain bearing assemblies, rolling-element bearing assemblies, and the like, such as in a rotary stage or other similar method, to restrict the motion of the main housing 11 relative to the rotational support 14 to a single axis of rotation. Optionally, the main housing 11 may be manually rotated and operated simply by turning it by hand. In other embodiments, the apparatus 100 may comprise an electric motor 33 (FIG. 4) or a spring wound mechanism configured to rotate the main housing 11 relative to a rotational support 14 and/or the surface which is supporting the apparatus 100. In further embodiments, the apparatus 100 may comprise a stepper motor with worm drive or a DC motor and encoder with worm drive configured to rotate the main housing 11 relative to a rotational support 14 and/or to the surface upon which is supporting the apparatus 100. In still further embodiments, the main housing 11 may be rotationally coupled to the rotational support 14 with a pull cord mechanism. In further alternative embodiments, the apparatus 100 and/or the main housing 11 may not be configured to rotate relative to the surface upon which the apparatus 100 is placed.

In other embodiments, one or more beverage container receiving surfaces 12 may be rotationally joined to the main housing 11 with one or more plain bearing assemblies or rolling-element bearing assemblies such as in a rotary stage or other similar method to restrict the motion of the beverage container receiving surfaces 12 relative to the main housing 11 to a single axis of rotation. Optionally, one or more beverage container receiving surfaces 12 may be manually rotated and operated simply by turning by hand. In other embodiments, the apparatus 100 may comprise an electric motor 33 or a spring wound mechanism configured to rotate the beverage container receiving surfaces 12 relative to the main housing 11 and/or the surface upon which the apparatus 100 is placed. In further embodiments, the apparatus 100 may comprise a stepper motor with worm drive or a DC motor and encoder with worm drive configured to rotate the beverage container receiving surfaces 12 relative to the main housing 11 and/or the surface upon which the apparatus 100 is placed. In still further embodiments, one or more beverage container receiving surfaces 12 may not be configured to rotate relative to the main housing 11.

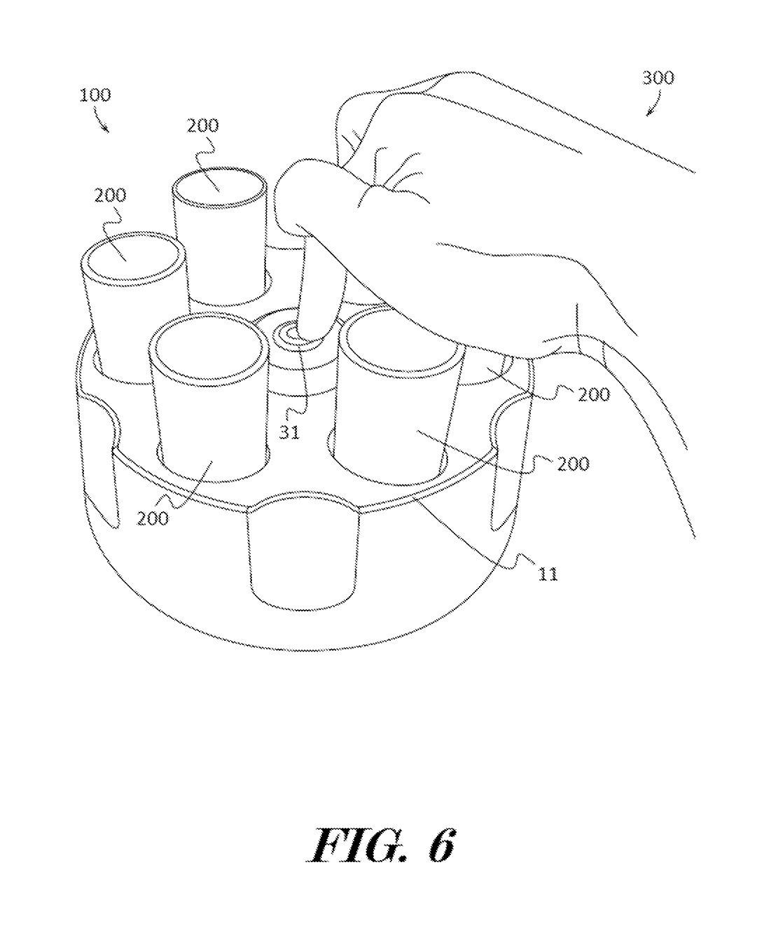

FIG. 4 depicts a plan view of the bottom of an example of a beverage container conveyance and illumination apparatus 100 according to various embodiments described herein. In some embodiments, an illumination unit 32 may be positioned under the main housing 11 proximate to a beverage container receiving surface 12. An illumination unit 32 may comprise a plurality of light emitting elements 17 and may be configured to illuminate portions of one or more beverage container receiving surfaces 12 and/or portions of the main housing 11 once a user interface 31 is interacted with. Once a user interface 31 is interacted with, such as by pressing on the user interface 31 as shown in FIG. 6, the illumination unit 32 may be configured to illuminate one or more beverage container receiving surfaces 12 and/or portions of the main housing 11 with the pattern, color, and/or intensity of the illumination controlled by one or more programs 28 (FIG. 5) of the processing unit 21.

In some embodiments, the illumination unit 32 may comprise one or more circuit boards 16 in wired communication with and a processing unit 21 and one, two, three, four, five, or more user interfaces 31. A circuit board 16 may comprise a printed circuit board (PCB) which mechanically supports and electrically connects electronic components using conductive tracks, pads and other features etched from copper sheets laminated onto a non-conductive substrate. PCBs can be single sided (one copper layer), double sided (two copper layers) or multi-layer. Conductors on different layers may be connected with plated-through holes called vias. In some embodiments, a circuit board 16 may only comprise copper connections and no embedded components and may be called a printed wiring board (PWB) or etched wiring board. In other embodiments, a circuit board 16 may comprise a printed circuit assembly (PCA), printed circuit board assembly or PCB assembly (PCBA), a circuit card assembly (CCA), or a backplane assembly, or any other suitable electrical connection and communication method including standard wiring and the like.

In some embodiments, a circuit board 16 may comprise one or more microcontrollers or LED drivers which may illuminate one or more light emitting elements 17 such as light emitting diodes (LEDs), and which may be positioned adjacent to the main housing 11 and/or to a beverage container receiving surface 12 so that when powered on, the light emitting elements 17 may be configured to illuminate portions of the main housing 11, a beverage container receiving surface 12, and/or a beverage container 200 (FIGS. 2 and 3) in contact with a beverage container receiving surface 12. One or more of the light emitting elements 17 may comprise red, green, blue (RGB) LEDs which may be configured to generate various colors and intensities of light allowing a plurality of color patterns and intensity patterns to be generated. In other embodiments, a circuit board 16 may comprise one or more other light emitting elements such as white LEDs, incandescent light bulbs, halogen light bulbs, laser light emitters, electroluminescent light source, neon light source, or any other suitable light source.

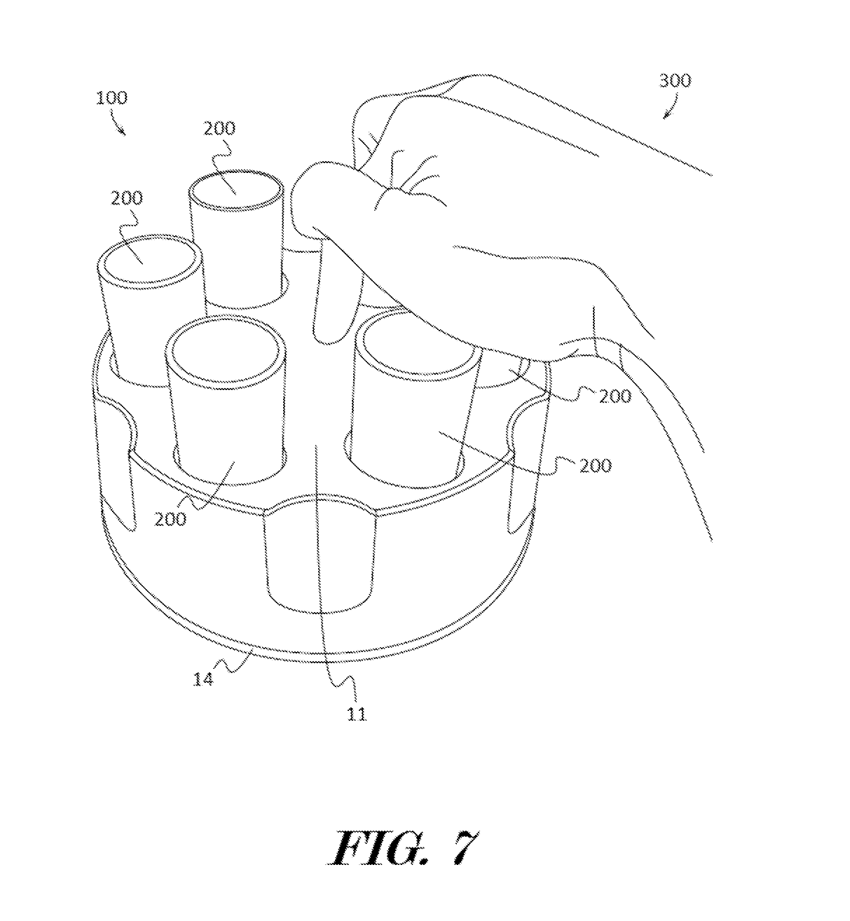

A processing unit 21 may be in wired or other electrical communication with a user interface 31 and an illumination unit 32. The processing unit 21 may be configured to modulate the illumination provided by the illumination unit 32 once a user interface 31 is activated by a user 300 such as shown in FIGS. 6 and 7. An optional battery pack 18 may receive a rechargeable or non-rechargeable battery, such as lithium ion battery, nickel cadmium battery, alkaline battery, or any other suitable type of battery, which may be used to supply electrical power to the processing unit 21, illumination unit 32, user interface 31, and any other electrical components. In further embodiments, an optional battery pack 18 may supply electrical power to the processing unit 21 which may modulate and supply electrical power to one or more optional motors 33 configured to rotate the main housing 11. In other embodiments, the apparatus 100 may be supplied with an alternating current power source which may be converted into direct current to supply electrical power to a processing unit 21 which may modulate and supply electrical power to a circuit board 16 and/or an optional motor 33.

FIG. 5 illustrates a block diagram showing some of the electronic elements an example of a beverage container conveyance and illumination apparatus 100 (FIGS. 1-4, 6, and 7) may comprise according to various embodiments described herein. In some embodiments and in the present example, the apparatus 100 can be a digital device that, in terms of hardware architecture, comprises a processing unit 21 which generally includes a processor 22, user interface 31, illumination unit 32, an optional motor 33, an optional radio 23, a data store 24, and memory 25. In some embodiments, the processing unit 21 may be positioned or contained within the main housing 11 as shown in FIG. 4. It should be appreciated by those of ordinary skill in the art that FIG. 5 depicts the apparatus 100 in an oversimplified manner, and a practical embodiment may include additional components or elements and suitably configured processing logic to support known or conventional operating features that are not described in detail herein. The components and elements (22, 31, 32, 33, 23, 24, and 25) are communicatively coupled via a local interface 26. The local interface 26 can be, for example but not limited to, one or more buses or other wired or wireless connections, as is known in the art. The local interface 26 can have additional elements, which are omitted for simplicity, such as controllers, buffers (caches), drivers, repeaters, and receivers, among many others, to enable communications. Further, the local interface 26 may include address, control, and/or data connections to enable appropriate communications among the aforementioned components.

The processor 22 is a hardware device for executing software instructions. The processor 22 can be any custom made or commercially available processor, a central processing unit (CPU), an auxiliary processor among several processors associated with the processing unit 21, a semiconductor-based microprocessor (in the form of a microchip or chip set), or generally any device for executing software instructions. When the processing unit 21 is in operation, the processor 22 is configured to execute software stored within the memory 25, to communicate data to and from the memory 25, and to generally control operations of the apparatus 100 pursuant to the software instructions. In an exemplary embodiment, the processor 22 may be configured to execute software programs which may modulate the illumination provided by the illumination unit 32, modulate rotation provided by a motor 33, or any other function of any other component. In further embodiments, the local interface 26 may provide electronic communication between the processor 22 and optional components which may include, for example, a serial port, a parallel port, a small computer system interface (SCSI), an infrared (IR) interface, a radio frequency (RF) interface, a universal serial bus (USB) interface, and the like.

An optional radio 23 enables wireless communication to an external access device or network. The radio 23 may be configured to send or receive information such as illumination patterns which may control or change the illumination provided by an illumination unit 32 or rotation patterns which may control or change the rotation provided by a motor 33. Optionally, a device such as a computer, tablet computer, smartphone, and like devices capable of wireless communication may send and receive data to a radio 23 allowing new programs 28 to be sent to the processing unit 21 allowing rotational movement patterns, light color patterns, light intensity patterns, and/or an illumination patterns to be adjusted according to user preference.

In some embodiments, a radio 23 may operate using Bluetooth wireless communication protocols. In further embodiments, a radio 23 may operate on a cellular band and may communicate with or receive a Subscriber Identity Module (SIM) card or other wireless network identifier. Any number of suitable wireless data communication protocols, techniques, or methodologies can be supported by the radio 23, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Near-Field Communication (NFC); Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication.

The data store 24 may be used to store data. The data store 24 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 24 may incorporate electronic, magnetic, optical, and/or other types of storage media.

The memory 25 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 25 may incorporate electronic, magnetic, optical, and/or other types of storage media. Note that the memory 25 may have a distributed architecture, where various components are situated remotely from one another, but can be accessed by the processor 22. The software in memory 25 can include one or more software programs, each of which includes an ordered listing of executable instructions for implementing logical functions such as illumination and/or rotation patterns.

In the example of FIG. 5, the software in the memory system 25 includes a suitable operating system (O/S) 27 and programs 28. The operating system 27 essentially controls the execution of component functions, and provides scheduling, input-output control, file and data management, memory management, and communication control and related services. The operating system 27 may be, for example, LINUX (or another UNIX variant), Android (available from Google), Symbian OS, Microsoft Windows CE, Microsoft Windows 7 Mobile, iOS (available from Apple, Inc.), webOS (available from Hewlett Packard), Blackberry OS (Available from Research in Motion), and the like. The programs 28 may include various applications, add-ons, etc. configured to provide end user functionality with the apparatus 100. For example, exemplary programs 28 may include, but not limited to, environmental variable analytics and modulation of user interface 31, illumination unit 32, and/or motor 33 functions. In a typical example, the end user typically uses one or more of the programs 28, which may be activated by a user interface 31, to generate illumination patterns, such as the color, duration, and/or intensity of the illumination, for the illumination unit 32. In another example, the end user typically uses one or more of the programs 28, which may be activated by a user interface 31, to rotate a beverage container receiving surface 12 and/or to rotate the main housing 11.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequence of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

The processing unit 21 may also include a main memory, such as a random access memory (RAM) or other dynamic storage device (e.g., dynamic RAM (DRAM), static RAM (SRAM), and synchronous DRAM (SDRAM)), coupled to the bus for storing information and instructions to be executed by the processor 22. In addition, the main memory may be used for storing temporary variables or other intermediate information during the execution of instructions by the processor 22. The processing unit 21 may further include a read only memory (ROM) or other static storage device (e.g., programmable ROM (PROM), erasable PROM (EPROM), and electrically erasable PROM (EEPROM)) coupled to the bus for storing static information and instructions for the processor 22.

In FIG. 6, a perspective view of a user 300 interacting with an example of a beverage container conveyance and illumination apparatus 100 according to various embodiments is shown. In this example, a user 300 may interact with the apparatus 100 in order to modulate the illumination unit 32 (FIGS. 4 and 5) by pressing a user interface 31 which comprises a depressible button positioned centrally on the main housing 11. In another example, a user 300 may interact a user interface 31 in order to activate a motor 33 (FIGS. 4 and 5) which may be configured to rotate the main housing 11 and/or a beverage container receiving surface 12 relative to a surface that is supporting the apparatus 100.

In some embodiments, a user interface 31 may be interacted with by pressing on the main housing 11 as shown in FIG. 7. In further embodiments, a user interface 31 may comprise one or more switches, knobs, levers, or any other suitable type of user interface configured to modulate a function of an illumination unit 32 (FIGS. 4 and 5). In further embodiments, a user interface 31 may comprise one or more switches, knobs, levers, or any other suitable type of user interface configured to modulate a function of a motor 33 (FIGS. 4 and 5). In additional embodiments, the main housing 11 may be rotationally coupled to a rotational support 14 (FIGS. 2, 3, and 7) with a spring type mechanism which is configured to rotate upon a user 300 pushing the main housing down 11 to activate the user interface 31. In alternative embodiments, the user interface 31 may be on a spring type mechanism and may be configured to rotate the main housing 11 and/or a beverage container receiving surface 12 upon a user 300 pushing the user interface 31 down, thereby activating the user interface 31.

In some embodiments, interaction with a user interface 31 may cause the processing unit 21 to operate a motor 33 (FIGS. 4 and 5) to initiate a rotational movement pattern of the main housing 11, a beverage container receiving surface 12, and/or a rotational support 14 (FIGS. 2 and 3). Also in some embodiments, interaction with a user interface 31 may cause the processing unit 21 to operate the illumination unit 32 to generate a light color pattern, a light intensity pattern, and/or an illumination pattern by one or more LEDs.

In some embodiments, one or more beverage container receiving surfaces 12 may have a user interface 31 coupled to a beverage container receiving surface 12 so that pushing or setting a beverage container 200 down on a beverage container receiving surface 12 may activate the illumination unit 32 and/or motor 33. In other embodiments, one or more of the beverage container receiving surfaces 12 may be separate from the main housing 11, and mounted on spring mechanisms that would elevate one or more beverage containers 200 simultaneously or individually, thereby prompting the user 300 to complete an action per rules of an accompanying game, and/or prompting the user 300 to push the beverage container 200 back down thereby activating a user interface 31.

In alternative embodiments, a user interface 31 may be positioned on a rotational support 14 so that rotation of the main housing 11 may activate the user interface 31 and modulate the illumination unit 32 (FIGS. 4 and 5). In further alternative embodiments, a user interface 31 may be positioned on a rotational support 14 (FIGS. 2, 3 and 7) so that by a pushing or pressing the main housing 11 down and towards the surface upon which the apparatus 100 has been placed may activate the user interface 31 and modulate the illumination unit 32 as shown in FIG. 7.

In preferred embodiments, interaction with a user interface 31 allows a user 300 to activate the processing unit 21 to modulate an illumination unit 32 (FIGS. 4 and 5) which is configured to illuminate one or more portions of the main housing 11, and/or to illuminate one or more beverage container receiving surfaces 12. Modulation of an illumination unit 32 (FIG. 4) may turn off or turn on illumination to one or more portions of the main housing 11 and/or optionally turn off or turn on illumination to one or more beverage container receiving surfaces 12, thereby forming an illumination pattern. In some embodiments, the main housing 11, beverage container receiving surfaces 12, and/or one or more beverage containers 200 may illuminate in a single color of light. In other embodiments, portions of the main housing 11, portions of one or more beverage container receiving surfaces 12, and/or one or more beverage containers 200 may illuminate in different colors of light and/or with different intensities of light.

In one example, modulation may cause an illumination unit 32 (FIGS. 4 and 5) to sequentially illuminate each beverage container receiving surface 12 in a circular clockwise or counterclockwise pattern of increasing illumination time for each adjacent and subsequent beverage container receiving surface 12 and then stopping the illumination on a single beverage container receiving surface 12.

In another example, modulation may cause an illumination unit 32 (FIGS. 4 and 5) to sequentially illuminate two or more beverage container receiving surfaces 12 in a circular clockwise or counterclockwise pattern of increasing illumination time for each adjacent and subsequent beverage container receiving surface 12 and then stopping the illumination on a single beverage container receiving surface 12.

In another example, modulation may cause an illumination unit 32 (FIGS. 4 and 5) to randomly illuminate each beverage container receiving surface 12 in a pattern of increasing illumination time for each subsequent beverage container receiving surface 12 and then stopping the illumination on a single beverage container receiving surface 12.

In an alternative example, modulation may cause an illumination unit 32 (FIGS. 4 and 5) to physically rotate thereby illuminating one or more beverage container receiving surfaces 12 in a circular clockwise or counterclockwise pattern of increasing illumination time by slowing its physical rotation speed and then stopping to illuminate a single beverage container receiving surface 12.

In a further alternative example, the main housing 11 or a beverage container receiving surface 12 may be rotated manually while modulation may cause a stationary illumination unit 32 (FIGS. 4 and 5) to illuminate one or more beverage container receiving surfaces 12 in a circular clockwise or counterclockwise pattern of increasing illumination time as the main housing slows its physical rotation speed and then stops causing the stationary illumination unit 32 to illuminate a single beverage container receiving surface 12.

In even further alternative examples, by interacting with a user interface 31, a motor 33 may be activated to rotate the main housing 11 or a beverage container receiving surface 12 for a period of time and then deactivated while modulation may cause a stationary illumination unit 32 (FIGS. 4 and 5) to illuminate one or more beverage container receiving surfaces 12 in a circular clockwise or counterclockwise pattern of increasing illumination time as the main housing slows its physical rotation speed, and then stops causing the stationary illumination unit 32 to illuminate a single beverage container receiving surface 12.

One skilled in the art will immediately recognize that modulation of an illumination unit 32 (FIGS. 4 and 5) may comprise many different illumination patterns, including random patterns, which may be employed to temporarily turn off or turn on illumination to one or more portions of the main housing 11 and/or optionally to turn off or turn on illumination to one or more beverage container receiving surfaces 12. Additionally, one skilled in the art will immediately recognize that the illumination unit 32 may remain stationary relative to the main housing 11 or a beverage container receiving surface 12 and be configured to sequentially turn off or turn on illumination to one or more portions of the main housing 11 and/or optionally to turn off or turn on illumination to one or more beverage container receiving surfaces 12 in order to give the illumination the appearance of rotating, or that the illumination unit 32 may actually rotate relative to the main housing 11 and be configured to sequentially turn off or turn on illumination to one or more portions of the main housing 11 and/or optionally to turn off or turn on illumination to one or more beverage container receiving surfaces 12 in order to give the illumination the appearance of rotation.

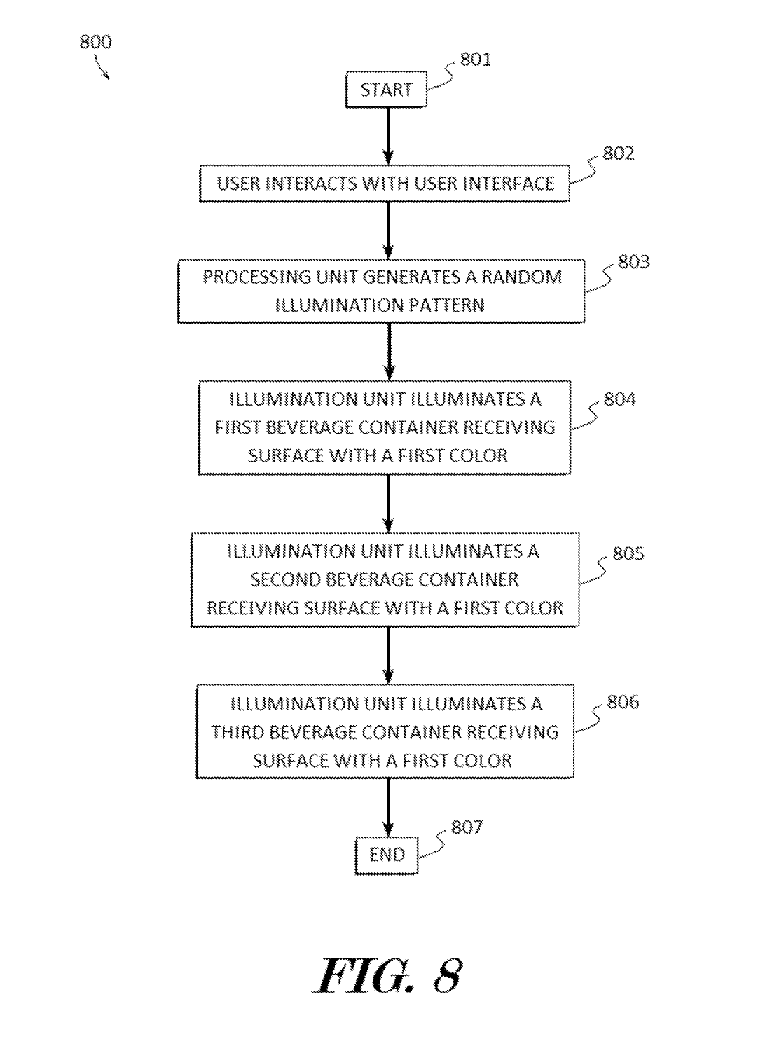

Turning now to FIG. 8, a block diagram of an example of a method (“the method”) 800 for illuminating a beverage container conveyance and illumination apparatus 100 (FIGS. 1-4, 6, and 7) according to various alternative embodiments described herein is depicted. In some embodiments, the method 800 may start 801 with a user 300 interacting with a user interface 31 in step 802. In further embodiments, a user 300 may interact with a user interface 31 comprising a depressible button positioned centrally on the main housing 11 by pressing and releasing the user interface 31 as shown in FIG. 6. In other embodiments, a user 300 may interact with a user interface 31 by pressing on and releasing the main housing 11 as shown in FIG. 7. In still other embodiments, a user 300 may interact with a user interface 31 by rotating the main housing 11 or a beverage container receiving surface 12. Next in step 803, the processing unit 21 (FIGS. 4 and 5) may generate a random illumination pattern. In some embodiments, an illumination pattern may comprise sequentially illuminating adjacent beverage container receiving surfaces 12 with a color of light until a random number of beverage container receiving surfaces 12 have been illuminated. In other embodiments, an illumination pattern may comprise randomly illuminating each beverage container receiving surface 12 with a color of light until a random number of beverage container receiving surfaces 12 have been illuminated. In this embodiment, the illumination unit 32 may illuminate a first beverage container receiving surface 12 with a first color of light in step 804. The illumination unit 32 may then illuminate a second beverage container receiving surface 12 with a first color of light in step 805. The illumination unit 32 may then illuminate a third beverage container receiving surface 12 with a first color of light in step 806 and the method 800 may end 807. In other embodiments, the illumination unit 31 may illuminate a random number of beverage container receiving surfaces 12, such as between four and two hundred beverage container receiving surfaces 12, with a first or one color of light. In the example method 800 of FIG. 8 three beverage container receiving surfaces 12 are illuminated with a first or one color of light. However, the method 800 may be accomplished with any number of beverage container receiving surfaces 12 being be illuminated one or more colors of light.

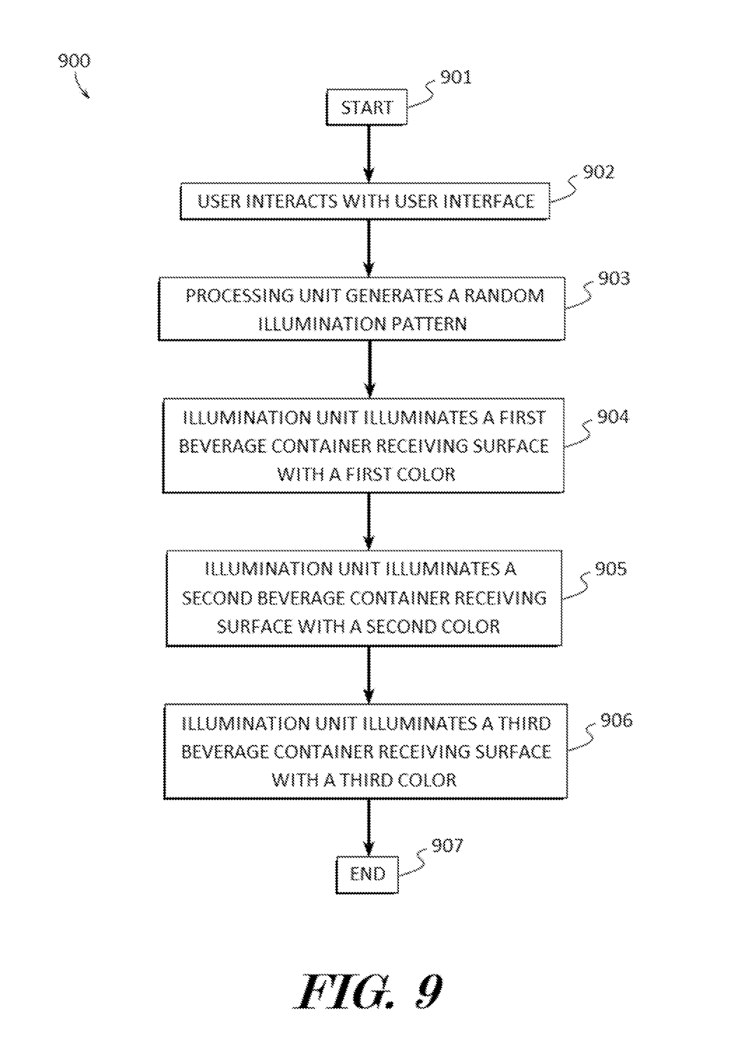

In reference to FIG. 9, a block diagram of an example of a method (“the method”) 900 for illuminating a beverage container conveyance and illumination apparatus 100 (FIGS. 1-4, 6, and 7) according to various alternative embodiments described herein is depicted. In some embodiments, the method 900 may start 901 with a user 300 interacting with a user interface 31 in step 902. In further embodiments, a user 300 may interact with a user interface 31 comprising a depressible button positioned centrally on the main housing 11 by pressing and releasing the user interface 31 as shown in FIG. 6. In other embodiments, a user 300 may interact with a user interface 31 by pressing on and releasing the main housing 11 as shown in FIG. 7. In still other embodiments, a user 300 may interact with a user interface 31 by rotating the main housing 11 or a beverage container receiving surface 12. Next in step 903, the processing unit 21 (FIGS. 4 and 5) may generate a random illumination pattern. In some embodiments, an illumination pattern may comprise sequentially illuminating adjacent beverage container receiving surfaces 12 with different colors of light until a random number of beverage container receiving surfaces 12 have been illuminated. In other embodiments, an illumination pattern may comprise randomly illuminating each beverage container receiving surface 12 with different colors of light until a random number of beverage container receiving surfaces 12 have been illuminated. In this embodiment, the illumination unit 32 may illuminate a first beverage container receiving surface 12 with a first color of light in step 904. The illumination unit 32 may then illuminate a second beverage container receiving surface 12 with a second color of light in step 905. The illumination unit 32 may then illuminate a third beverage container receiving surface 12 with a third color of light in step 906 and the method 900 may end 907. In other embodiments, the illumination unit 31 may illuminate a random number of beverage container receiving surfaces 12, such as between four and two hundred beverage container receiving surfaces 12, different colors of light before ending 907. In the example method 900 of FIG. 9 three beverage container receiving surfaces 12 are illuminated with three different colors of light. However, the method 900 may be accomplished with any number of beverage container receiving surfaces 12 being be illuminated with one or more colors of light.

While some materials have been provided, in other embodiments, the elements that comprise the apparatus 100 such as the main housing 11, a beverage container receiving surface 12, user interface 31, optional beverage containers 200, optional beverage container receiving surface sidewall 13, and/or optional rotational support 14 may be made from durable materials such as aluminum, steel, other metals and metal alloys, wood, hard rubbers, hard plastics, fiber reinforced plastics, carbon fiber, fiber glass, resins, polymers or any other suitable materials including combinations of materials. Additionally, one or more elements may be made from or comprise durable and slightly flexible materials such as soft plastics, silicone, soft rubbers, or any other suitable materials including combinations of materials. In some embodiments, one or more of the elements that comprise the apparatus 100 may be coupled or connected together with heat bonding, chemical bonding, adhesives, clasp type fasteners, clip type fasteners, rivet type fasteners, threaded type fasteners, other types of fasteners, or any other suitable joining method. In other embodiments, one or more of the elements that comprise the apparatus 100 may be coupled or removably connected by being press fit or snap fit together, by one or more fasteners such as hook and loop type or Velcro® fasteners, magnetic type fasteners, threaded type fasteners, sealable tongue and groove fasteners, snap fasteners, clip type fasteners, clasp type fasteners, ratchet type fasteners, a push-to-lock type connection method, a turn-to-lock type connection method, slide-to-lock type connection method or any other suitable temporary connection method as one reasonably skilled in the art could envision to serve the same function. In further embodiments, one or more of the elements that comprise the apparatus 100 may be coupled by being one of connected to and integrally formed with another element of the apparatus 100.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A beverage container conveyance and illumination apparatus, the apparatus comprising:
a main housing;
a user interface;
a beverage container receiving surface; and
an illumination unit comprising a plurality of light emitting elements, wherein the illumination unit is configured to illuminate a beverage container receiving surface once the user interface is interacted with.

2. The apparatus of claim 1, further comprising a rotational support rotationally coupled to the main housing.

3. The apparatus of claim 2, wherein the rotational support is configured to allow the main housing to rotate relative to a surface that is supporting the apparatus.

4. The apparatus of claim 1, wherein the main housing is configured to receive a plurality of beverage containers.

5. The apparatus of claim 1, wherein the main housing is configured to receive six beverage containers.

6. The apparatus of claim 1, wherein the user interface comprises a depressible button positioned centrally on the main housing.

7. The apparatus of claim 1, wherein interaction with the user interface activates the illumination unit to sequentially illuminate adjacent beverage container receiving surfaces.

8. The apparatus of claim 1, wherein the user interface is interacted with by pressing on the main housing.

9. The apparatus of claim 1, wherein interaction with the user interface activates the illumination unit to randomly illuminate each beverage container receiving surface.

10. The apparatus of claim 1, wherein the light emitting elements comprise light emitting diodes (LEDs).

11. The apparatus of claim 1, wherein the light emitting elements comprise red, green, blue (RGB) LEDs.

12. The apparatus of claim 2, wherein the apparatus comprises a plurality of beverage container receiving surfaces.

13. The apparatus of claim 13, wherein each beverage container receiving surface is configured to receive one beverage container.

14. The apparatus of claim 14, wherein the rotational support is configured to allow the main housing to rotate relative to a surface that is supporting the apparatus.

15. The apparatus of claim 14, wherein the illumination unit is configured to sequentially illuminate each beverage container receiving surface.

16. The apparatus of claim 14, wherein the illumination unit is configured to randomly illuminate each beverage container receiving surface.

17. The apparatus of claim 1, wherein the illumination unit is configured to illuminate portions of the main housing.

18. The apparatus of claim 1, wherein the illumination unit is configured to illuminate portions of a beverage container receiving surface.

19. The apparatus of claim 1, further comprising a motor, wherein the motor is configured to rotate the main housing to rotate relative to a surface that is supporting the apparatus.

20. The apparatus of claim 1, wherein interaction with the user interface activates the motor to rotate the main housing relative to a surface that is supporting the apparatus.
